(19) United States
(12) Patent Application Publication
(10) Pub. No.: US 2012/0122557 A1
(43) Pub. Date: May 17, 2012

(54) CARD READER

(75) Inventors: Robert G. Kowolik, Henderson, NV (US); James W. Stockdale, Clio, CA (US); Aaron Hightower, Las Vegas, NV (US); Alexander Popovich, Henderson, NV (US); William McMaster, Las Vegas, NV (US)

(73) Assignee: IGT, Reno, NV (US)

(21) Appl. No.: 12/946,562

(22) Filed: Nov. 15, 2010

(51) Int. Cl. A63F 9/24; G06K 7/14; G06K 7/01

(52) U.S. Cl. 463/25; 235/462.41; 235/462.11; 235/462.15

(57) ABSTRACT

A card reader may be configured for reading a bar code on a card, regardless of whether the bar code is on a first side of the card or a second side of the card. The card reader may be implemented in a wager gaming machine or in another context. If a card has a bar code printed on the first side and decorative material printed on the second side, the card reader may be configured to read the bar code regardless of the card's orientation. The bar code may be a two-dimensional bar code. A controller of the card reader may be configured for determining whether the bar code contains player tracking account information and/or other information regarding a person associated with the card.

### FIELD OF THE INVENTION

This application relates to card reading devices, systems and methods. Some embodiments described herein relate to card readers for player tracking devices used with wager gaming machines.

### BACKGROUND OF THE INVENTION

For gaming machine operators, such as casino operators, it can be advantageous to determine the game playing habits of individual game players. When the game playing habits of an individual player are known, the gaming machine operator may provide incentives corresponding to the game playing habits of the individual game player to encourage additional game play. For example, the gaming machine operator may provide an individual player with coupons for free meals, free rooms or discounted game play depending on their game playing habits. The game playing habits of individual game players are typically determined by monitoring game usage on a gaming machine using a player tracking unit. (The terms “player tracking” and “player loyalty” may be used interchangeably herein.) The player tracking unit may be configured to collect game usage data and player identification information from the gaming machine, which may be sent to another device (such as a server) for archival and/or analysis purposes.

A player tracking unit may identify a player according to information that is provided on a player loyalty instrument, such as a player tracking card. Various types of player tracking cards have been described and/or implemented, including cards having a magnetic strip, cards having a bar code and cards configured for radio frequency identification (“RFID”). Although current player tracking cards and readers are generally acceptable, it would be desirable to provide improved devices and methods.

### SUMMARY

Some embodiments described herein provide a card reader configured for reading a bar code on a card, regardless of whether the bar code is on a first side of the card or a second side of the card. For example, if a card has a bar code printed on the first side and decorative material printed on the second side, some such card readers may be configured to read the bar code regardless of the card's orientation. In some embodiments, the bar code may be a two-dimensional bar code. A controller of the card reader may be configured for determining whether the bar code contains player tracking account information and/or other information regarding a person associated with the card.

Wager gaming machines are described herein. Some such wager gaming machines, include the following elements: apparatus for accepting indicia of credit; apparatus for providing wagering games; apparatus for accepting wagers relating to the wagering games; a master gaming controller; and a card reader. The master gaming controller may be configured to control the apparatus for providing wagering games, at least in part according to received wagers and indicia of credit. The card reader may include the following elements: a frame configured for receiving a card; a camera; a first optical pathway configured for conveying an image of a first side of the card to the camera; a second optical pathway configured for conveying an image of a second side of the card to the camera; and a card reader controller configured for determining whether the first side of the card or the second side of the card includes a bar code. The card reader controller may be configured for communication with the master gaming controller.

The wager gaming machine may also include a player tracking unit. In some embodiments, the card reader may be part of the player tracking unit.

The wager gaming machine may include a network interface. The card reader controller may be further configured for the following: reading bar code data from the bar code; sending the bar code data to a remote device via the network interface; and receiving an indication from the remote device regarding whether the bar code contains player tracking account information.

Various card readers are provided herein. Some such card readers include the following elements: a frame configured for receiving a card; a camera; a first optical pathway configured for conveying an image of a first side of the card to the camera; a second optical pathway configured for conveying an image of a second side of the card to the camera; and a controller configured for determining whether the first side of the card or the second side of the card includes a bar code. The camera may be fixedly positioned relative to the frame.

The controller may be further configured for reading the bar code. The controller may be configured for reading the bar code regardless of whether the bar code is on the first side of the card or the second side of the card. The card reader may include a network interface. The controller may be configured for sending bar code data to a remote device via the network interface and for receiving an indication from the remote device regarding whether the bar code contains player tracking account information. Alternatively, or additionally, the controller may be configured for determining whether the bar code contains player tracking account information.

The card reader may include an interface. The controller may be configured for communication with a wager gaming machine via the interface.

The first optical pathway may include a first pair of mirrors and the second optical pathway may include a second pair of mirrors. In some embodiments, the first optical pathway and the second optical pathway share at least one element. The frame may include at least one element of the first optical pathway or the second optical pathway. The card reader may include a detector configured to determine whether the card has been fully inserted into the frame.

A player tracking unit may include the card reader. A wager gaming machine may include the player tracking unit.

Various methods are provided herein. Some such methods, include the following steps: receiving, at an image capturing device, a first image of a first side of a card from a first mirror; receiving, at the image capturing device, a second image of a second side of the card from a second mirror; determining, by a controller configured for communication with the image capturing device, whether the first image or the second image includes a bar code; and reading the bar code if it is determined that the first image or the second image includes a bar code.

The method may involve determining whether the card has been fully inserted into a card reader. The method may involve providing an audio or visual prompt if it is determined that the card has not been fully inserted into the card reader.

The determining process may involve determining whether a pattern is detected in the first image or the second image. The determining process may involve determining whether the pattern is a position pattern or an alignment pattern.

The bar code may include player tracking information. The method may involve sending the player tracking information to a player tracking server.

Some devices provided herein include the following elements: apparatus for receiving a first image of a first side of a card and for receiving a second image of a second side of the card; apparatus for determining whether the first image or the second image includes a bar code; and apparatus for reading the bar code if the determining apparatus determines that the first image or the second image includes a bar code. The bar code may be a two-dimensional bar code. The bar code may include player tracking information. The device may also include apparatus for sending the player tracking information to a player tracking server.

Some embodiments may be provided via software stored in one or more tangible, machine-readable media. The software may include instructions for controlling one or more devices to perform various functions. For example, the software may include instructions for controlling a card reader to perform the following operations: receive a first image of a first side of a card; receive a second image of a second side of the card; determine whether the first image or the second image includes a bar code; and read the bar code if it is determined that the first image or the second image includes a bar code.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A depicts a first side of a card having a two-dimensional bar code printed thereon.

FIG. 1B depicts a second side of the card depicted in FIG. 1A, having a decorative pattern printed thereon.

FIG. 2A is a schematic depiction of components of a card reader according to one embodiment.

FIG. 2B is a perspective diagram depicting components of a card reader similar to the card reader shown in FIG. 2A.

FIG. 3 is a block diagram of one embodiment of a player tracking unit that includes a card reader as provided herein.

FIG. 4 is a flow chart that describes a method that may be implemented by a card reader as provided herein.

FIGS. 5A-C are front and perspective diagrams of a player tracking unit that may include a card reader as provided herein.

FIG. 6 is perspective drawing of a gaming machine that may include a card reader as provided herein.

### DETAILED DESCRIPTION

Certain features that are described in this specification in the context of separate embodiments also can be implemented in combination in a single embodiment. Conversely, various features that are described in the context of a single embodiment also can be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be described and/or depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single product or packaged into multiple products. Additionally, other embodiments are within the scope of the following claims. In some cases, the actions recited in the claims can be performed in a different order and still achieve desirable results.

Although gaming-related applications are described extensively herein, the described devices, systems and methods have broad applicability outside of the gaming context. For example, cards (and other objects) bearing bar codes may be used in a security context, e.g., to permit or deny access to a secure area. Such devices may also be used to identify the bearer and/or to facilitate commercial transactions, e.g., to provide information regarding the identity of a credit or debit card holder.

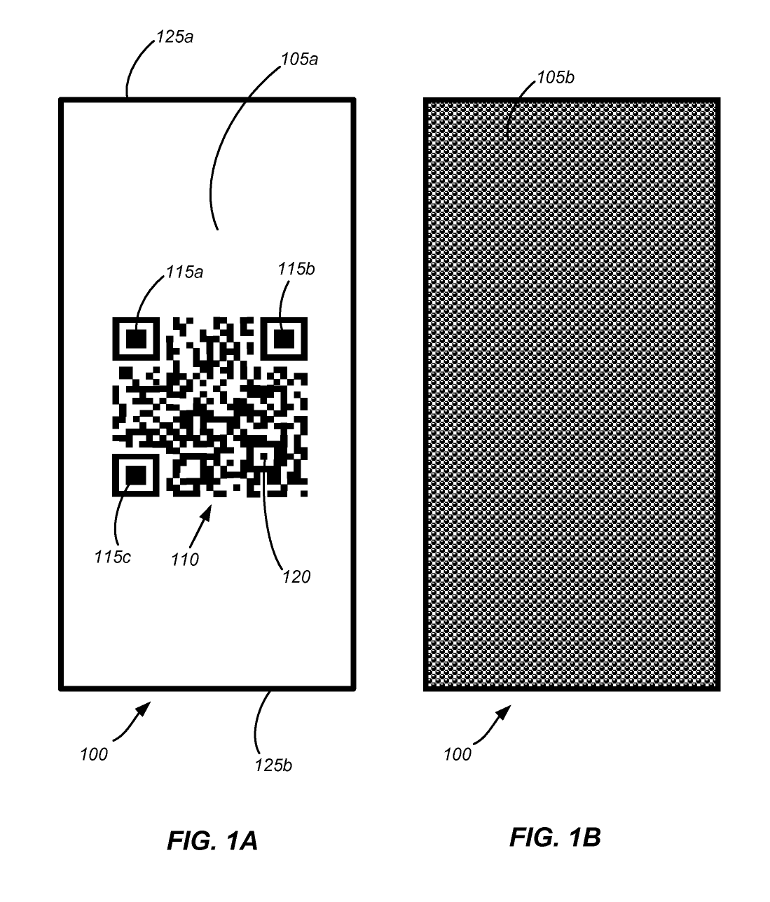

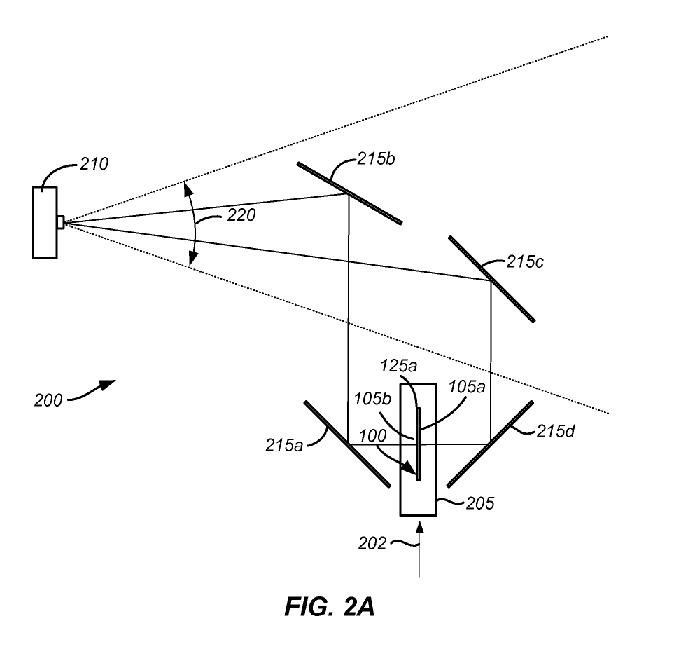

FIGS. 1A and 1B illustrate one example of a card 100 that may be used to implement some embodiments described herein. FIG. 1A depicts a first side 105a of card 100, which includes a bar code 110. FIG. 1B depicts a second side of the card 100 depicted in FIG. 1A, having a decorative pattern printed thereon. Although the pattern indicated in FIG. 1B is a simple pattern, many casinos use one side of a player card to display the casino name, logo, advertisements and/or other material.

In this example, the bar code 110 is a two-dimensional or “matrix” bar code that has been printed on the first side 105a. In alternative embodiments, the bar code 110 may be another type of bar code, such as a one-dimensional bar code, a three-dimensional bar code, or another type of two-dimensional bar code.

In this example, the bar code 110 is in “quick response” or QR format. As such, the bar code 110 includes position patterns 115a, 115b and 115c, as well as alignment pattern 120. Various combinations of these patterns may be used to determine the proper orientation of the bar code 110, regardless of the orientation of the card 100. For example, whether a player inserts end 125a or end 125b into a card reader, the orientation of the bar code 110 may be determined by reference to position patterns 115a, 115b and 115c, and/or with reference to alignment pattern 120. Similarly, an image of a decorative side of a card (such as the side 105b depicted in FIG. 1B) may be differentiated from an image that includes a bar code based, at least in part, on the presence or absence of position patterns 115 and/or alignment pattern 120.

Position patterns 115 and alignment pattern 120 of QR-type bar code 110 are merely examples of patterns that may be used to detect a bar code and to determine its orientation. As such, various other types of bar codes may be used to implement embodiments described herein. Whether or not bar code 110 is a QR-type bar code, the presence or absence of a predetermined pattern—whether in the bar code or on another portion of the card 100—may be used (e.g., by a controller associated with a card reader) to determine the orientation of the bar code 110. Similarly, in some embodiments a controller associated with a card reader may differentiate an image of a side of a card that includes a bar code from an image of a side of a card that does not include a bar code based, at least in part, on the presence or absence of a predetermined pattern.

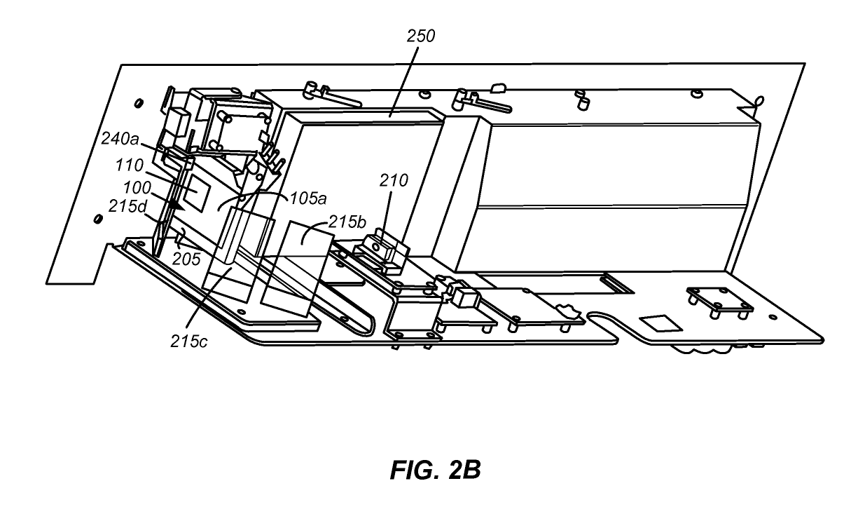

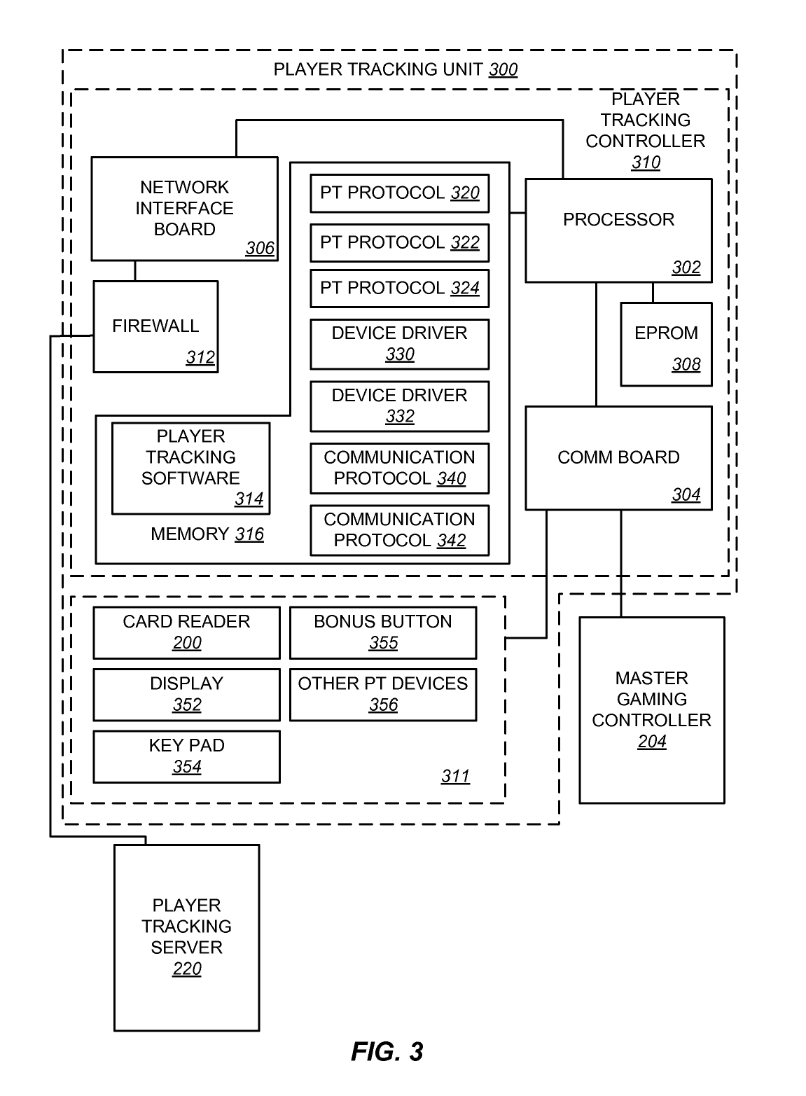

FIG. 2A is a schematic depiction of components of a card reader according to one embodiment. Here, the card reader 200 includes a frame 205 into which card 100 may be inserted and which holds the card 100 as it is being read. The card 100 has been inserted into the card reader 200 in the direction indicated by arrow 202. The card 100 may be illuminated in any convenient fashion, e.g., by a light-emitting diode or by another such light source disposed within card reader 200.

In this example, the side 105a, bearing the bar code 110 (not shown in FIG. 2A), faces mirror 215d. An image of the bar code 110 may travel along a first optical pathway to a light detector such as that of the camera 210. Here, the first optical pathway includes a pair of mirrors 215c and 215d. An image of the side 105b may be received by the camera 210 via a second optical pathway, which is formed by mirrors 215a and 215b in this example. The mirror 215b is offset and positioned substantially out of the first optical pathway, so that the mirror 215b does not block images from mirrors 215c and 215d. The field of view 220 of the camera 210 is sufficiently wide to capture images from mirrors 215b and 215c. Regardless of whether end 125a or end 125b of the card 100 is inserted into the frame 205 and regardless of which side of the card 100 the bar code 110 is on, the camera 210 can receive an image that includes the bar code 110.

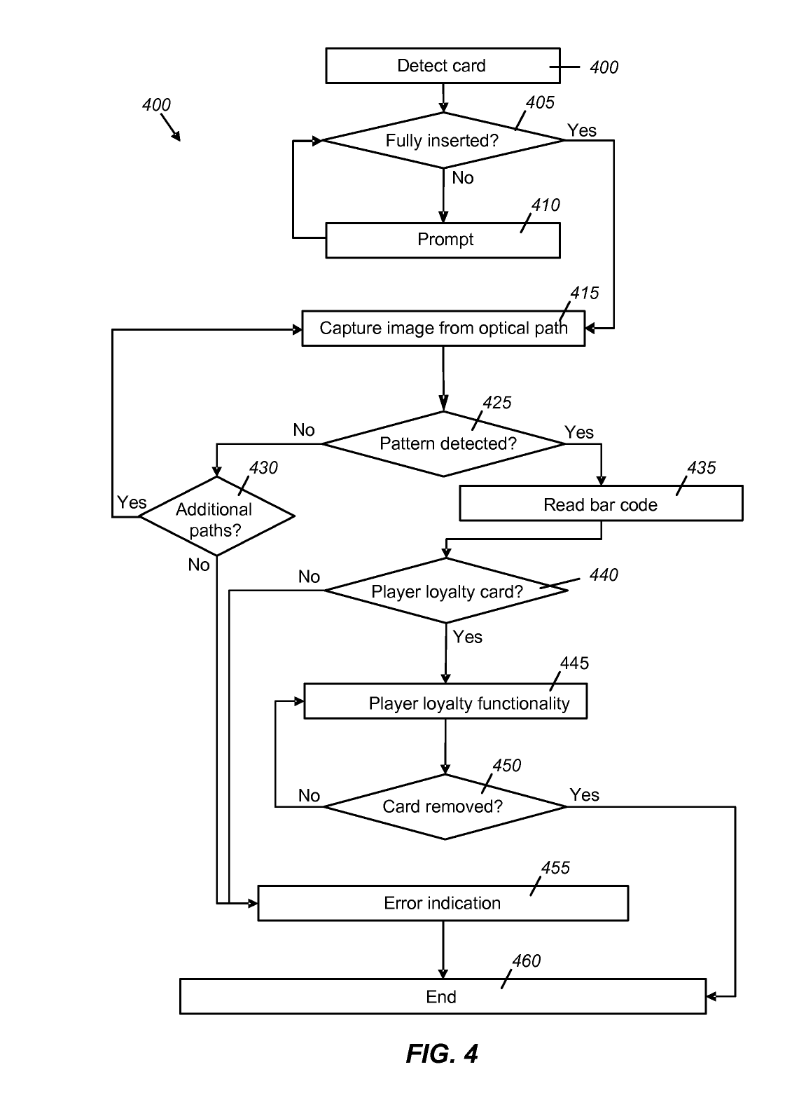

A controller (e.g., one such as described below with reference to FIG. 3) may be configured to receive image data from the camera 210. The controller may determine which side of the card 100 includes the bar code 110, as well as the orientation of the bar code 110, based on a predetermined pattern formed on the card 100. Having determined the position and orientation of the bar code 110, the controller can read the bar code 110. Accordingly, the card reader 200 can read the bar code 110 regardless of the orientation of the card 100.

The numbers, types and arrangements of elements depicted in FIG. 2A are only set forth by way of example. In some alternative embodiments, the first optical pathway and the second optical pathway may share at least one element. According to some such embodiments, separate mirrors 215b and 215c may be replaced by a single mirror. This mirror may be made large enough to reflect light from both mirror 215a and mirror 215d.

In some alternative embodiments, frame 205, mirror 215a and/or mirror 215d may be formed as a single unit. For example, frame 205 may be formed of a reflective material (such as aluminum, stainless steel, etc.) and may include reflective surfaces that are positioned substantially as mirrors 215a and 215d are positioned. Alternatively, some portions of frame 205 may include reflective surfaces on which a thin film of reflective material has been deposited. The remaining portions of frame 205 may or may not be formed of reflective material, depending on the implementation details. According to some embodiments, the reflective surfaces may be continuous, e.g., in a “U” shape or a “V” shape, so that the portions functioning as mirrors 215a and 215d may not be entirely separated.

According to some embodiments, the first and second optical pathways may not be substantially in the same plane. For example, mirror 215d could direct light to a mirror positioned in a plane above the card 100 and mirror 215a could direct light to a mirror positioned in a plane below the card 100, or vice versa. The out-of-plane mirrors could be configured to direct their respective images to the camera 210.

Other embodiments may have more or fewer mirrors or cameras. For example, some alternative embodiments may include a camera positioned on each side of the card 100. No mirrors 215 are necessary in such embodiments.

Other alternative embodiments may have two mirrors and two cameras. For example, mirrors such as 215a and 215d could be positioned substantially as shown in FIG. 2A, with each of mirrors 215a and 215d directing images to a different camera. Optical paths having even numbers of mirrors can present an image in its original orientation, whereas optical paths having odd numbers of mirrors will present an image in a reversed orientation. Embodiments that include optical paths having even numbers of mirrors may be cheaper to implement, in part because the associated software may need to recognize only bar codes in their normal orientations, not bar codes having reversed orientations.

Some alternative embodiments may employ optical fibers in at least part of the first and second optical pathway. Such implementations could, for example, include a lens assembly at each end of two optical fibers configured to guide images from sides 105a and 105b to a light detector located in any desired location within (or outside of) the card reader. On the end of the optical fibers near the frame 205, the lens assemblies may be configured to couple light reflected from the card 100 into the optical fibers. The lens assemblies on the distal end of the optical fibers may be configured to extract light from the optical fibers and to convey a card image to the camera 210. In alternative embodiments, optical coupling devices may be configured to convey images directly from the optical fibers to a light detection device. In either embodiment, mirrors 215 would not be necessary.

FIG. 2B is a perspective diagram depicting components of a card reader that is similar to the card reader shown in FIG. 2A. The card 100 has been inserted into the frame 205. The bar code 110 may be seen on side 105a of the card 100. An image of the bar code may be conveyed to the camera 210 via the mirrors 215d and 215c. An image of the side 105b may be conveyed to the camera 210 via the mirrors 215a (not visible in FIG. 2B) and 215c.

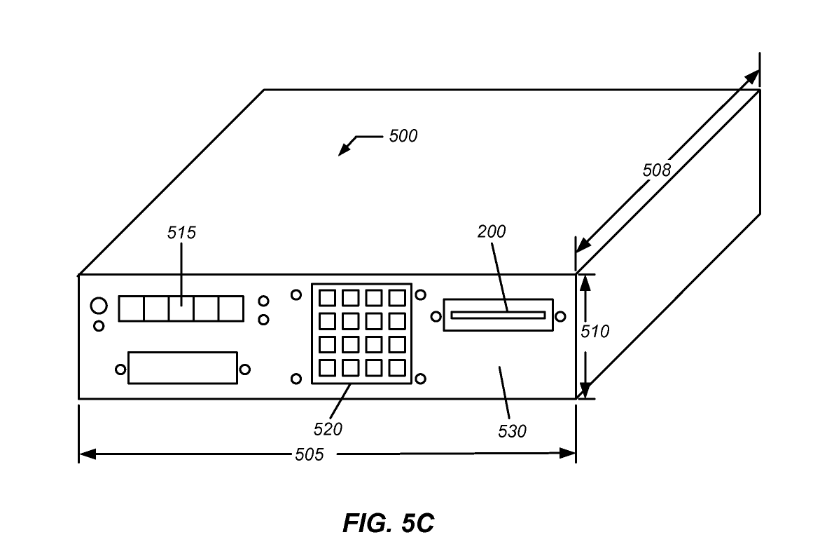

Light source 240a provides illumination for the side 105a of the card 100. Corresponding light source 240b (not visible in FIG. 2B) provides illumination for the side 105b of the card 100. Housing 250 encloses other components that are not visible in FIG. 2B, which may be user input devices and/or components of a player tracking device, e.g., such as those described below with reference to FIG. 3 and FIGS. 5A through 5C.

FIG. 3 is a block diagram of an embodiment of a player tracking unit 300 configured for communication with a master gaming controller 204 of a gaming machine and a player tracking server 220. The player tracking network may include various other devices not depicted in FIG. 3, such as a data collection units and translators, etc. The player tracking unit 300 includes a player tracking controller 310 enclosed in a housing and a number of player tracking devices including a card reader 200 (which may be any card reader provided herein), a display 352, a key pad 354 and other player tracking devices 356 enclosed in a device housing 311. The player tracking controller 310 for the player tracking unit and the player tracking devices may be enclosed in a single housing (see FIGS. 5A-5C) or in separate housings.

Here, the player tracking controller 310 includes at least one processor 302 for executing software allowing the player tracking unit to perform various functions such as communicating with the player tracking server 220, communicating with the master gaming controller 204 and operating the various peripheral devices such as the card reader 200, the display 352, the key pad 354 and the bonus button 355. For example, a processor 302 may be configured for performing at least some of the card reader functionality described herein. In alternative embodiments, the card reader 200 may have its own controller, including one or more processors, for performing at least some of the card reader functionality described herein. For example, the player tracking controller 310 may send messages containing player tracking information to the display 352.

In one embodiment, application software for the player tracking unit 300 and configuration information for the player tracking unit may be stored in a memory system 316, which may include devices such as an EPROM 308, a non-volatile memory, hard drive and/or a flash memory. The memory system 316 may be configured to store player tracking software 314, such as data collection software.

In this example, the player tracking unit 300 is configured as a “universal” player tracking unit that is configured to communicate with various different types of gaming machines and various different types of player tracking servers. The player tracking unit 300 may, for example, be configured as described in U.S. Pat. No. 6,722,985, entitled “UNIVERSAL PLAYER TRACKING SYSTEM,” which is hereby incorporated by reference. Accordingly, the memory system 316 may also store the following: 1) player tracking protocols (e.g. 320, 322, 324) allowing the player tracking unit 300 to communicate with different types of player tracking servers; 2) device drivers for many types of player tracking devices (e.g. 330 and 332); and 3) communication protocols (e.g. 340 and 342) such as TCP/IP allowing the player tracking unit to communicate with devices using these protocols or communication protocols allowing the logic device to communicate with different types of master gaming controllers (e.g. master gaming controllers using different types of communication protocols), such as 204. The master gaming controller 204 may communicate using a serial communication protocol. A few examples of serial communication protocols that may be used to communicate with the master gaming controller include but are not limited to Universal Serial Bus (“USB”), Recommended Standard 232 (“RS-232”) and Netplex™ (a proprietary protocol developed by IGT, Reno, Nev.).

A plurality of device drivers may be stored in memory 316 for each type of player tracking device. For example, device drivers for five different types of card readers, six different types of displays and 8 different types of key pads may be stored in the memory 316. (These numbers are stated merely by way of example.) When one type of a particular peripheral device is exchanged for another type of the particular device, a new device driver may be loaded from the memory 316 by the processor 302 to allow communication with the device. For instance, one type of card reader 200 in the player tracking unit 300 may be replaced with a second type of card reader 200. Device drivers for both card readers may be stored in the memory 316.

In some embodiments, the software units stored in the memory 316 may be upgraded as needed. For instance, when the memory 316 is a hard drive, new device drivers or new communication protocols may be uploaded (or downloaded) to the memory from the master gaming controller 204, the player tracking server 220 or from some other external device (such as a server), e.g., via network interface board 306. As another example, when the memory 316 is a CD/DVD drive containing a CD/DVD designed or configured to store the player tracking software 314, the device drivers and other communication protocols, the software stored in the memory may be upgraded by replacing a first CD/DVD with a second CD/DVD. In yet another example, when the memory 316 uses one or more flash memory units designed or configured to store the player tracking software 314, the device drivers and other communication protocols, the software stored in the flash memory units may be upgraded by replacing one or more flash memory units with new flash memory units storing the upgraded software.

In some embodiments, a minimal set of player tracking software applications 314, communication protocols 340, player tracking communication protocols and device drivers may be stored on in the memory 316. For instance, an operating system, a communication protocol allowing the player tracking unit 300 to communicate with a remote server such as the player tracking server 220 and one or more common player tracking applications may be stored in memory 316. When the player tracking unit is powered up, the player tracking unit 300 may contact a remote server 220 and download specific player tracking software from the remote software. The downloaded software may include, but may not be limited to, one or more particular player tracking applications that are supported by the remote server, particular device drivers, player tracking software upgrades, and a particular communication protocol supported by the remote server.

In some embodiments, player tracking functions may be implemented by both the player tracking controller 310 and the master gaming controller 204. Thus, player tracking software such as the player tracking protocols may be stored on a memory located on the gaming machine which is separate from the player tracking unit. In some embodiments, the player tracking software stored on the memory of the gaming machine may be executed by the master gaming controller 204 on the gaming machine. In other embodiments, the player tracking software stored on the memory on the gaming machine may be executed by the player tracking controller 310 on the player tracking unit.

In this example, the player tracking controller 310 includes a network interface board 306 configured or designed to allow communication between the player tracking unit 300 and other devices. Such devices may include the player tracking server 220, which may reside on a local area network (such as a casino area network) or a wide area network such as the Internet. The network interface board 306 may allow wireless or wired communication with the remote devices.

The network interface board may be connected to a firewall 312. The firewall 312 may be hardware, software or combinations of both that prevent illegal access of the gaming machine by an outside entity connected to the gaming machine. In this example, the firewall 312 is an internal firewall designed to prevent a hacker from gaining illegal access to the player tracking unit or gaming machine and tampering with it in some manner. For instance, an illegal access may be an attempt to plant a program in the player tracking unit that alters the operation of the gaming machine allowing it to perform an unintended function.

The communication board 304 may be configured to allow communication between the player tracking controller 310 and the player tracking devices 200, 352, 354, 355 and 356. The communication board 304 may also be configured to allow communication to allow communication between the player tracking controller 310 and the master gaming controller 204. The communication between the player tracking unit 300 and any other external or internal gaming devices may be encrypted.

In some embodiments, the player tracking controller 310 may poll the player tracking devices for information. For instance, the player tracking controller 310 may poll the card reader 200 to determine when a card has been inserted into the card reader or may poll the bonus button to determine when the bonus button 355 has been depressed. In some embodiments, the player tracking devices may contact the player tracking controller 310 when a player tracking event such as a card being inserted into the card reader has occurred. For example, a detector (such as a pressure sensor or a switch) may determine whether a card 100 has been fully inserted into the frame 205 of card reader 200. The detector may be configured for communication with player tracking controller 310 and/or with a controller of card reader 200.

The player tracking controller 310 may poll the master gaming controller 204 for game usage information. For instance, the processor 302 may send a message to the master gaming controller 204 such as “coin-in”. The master gaming controller may respond to the “coin-in” message with an amount when credits are registered on the gaming machine.

The player tracking controller 310, using an appropriate device driver, may send instructions to the various player tracking devices to perform specific operations. For instance, after a card has been inserted into the card reader 352, the processor logic device may send a “read card” instruction to the card reader and a “display message A” instruction to the display 352. In addition, the player tracking controller 310 may be configured to allow the master gaming controller 204 to send instructions to the player tracking devices via the player tracking controller 310. As an example, after a card has been inserted into the card reader 352, the processor logic 310 may determine that the card is for a gaming application controlled by the master gaming controller 204 and send a message to the master gaming controller 204 indicating a card has been inserted into the card reader. In response to the message from the processor 310, the master gaming controller 204 may send a series of commands to the player tracking devices such as a “read card” instruction to the card reader 200 and a “display message” instruction to the display 352 via the player tracking controller 310. The instructions from the master gaming controller to the player tracking devices may be obtained from gaming application software executed by the master gaming controller 204. The gaming application software may or may not be related to player tracking services.

The player tracking unit 300 may include one or more standard peripheral communication connections (not shown). The player tracking controller 310 may be designed or configured to communicate with the master gaming controller 204 using a standard peripheral connection using a standard communication protocol such as USB. The USB standard allows for a number of standard USB connectors that may be used with the present invention. The player tracking unit 300 may contain a hub connected to the peripheral communication connection and containing a plurality of peripheral communication connections.

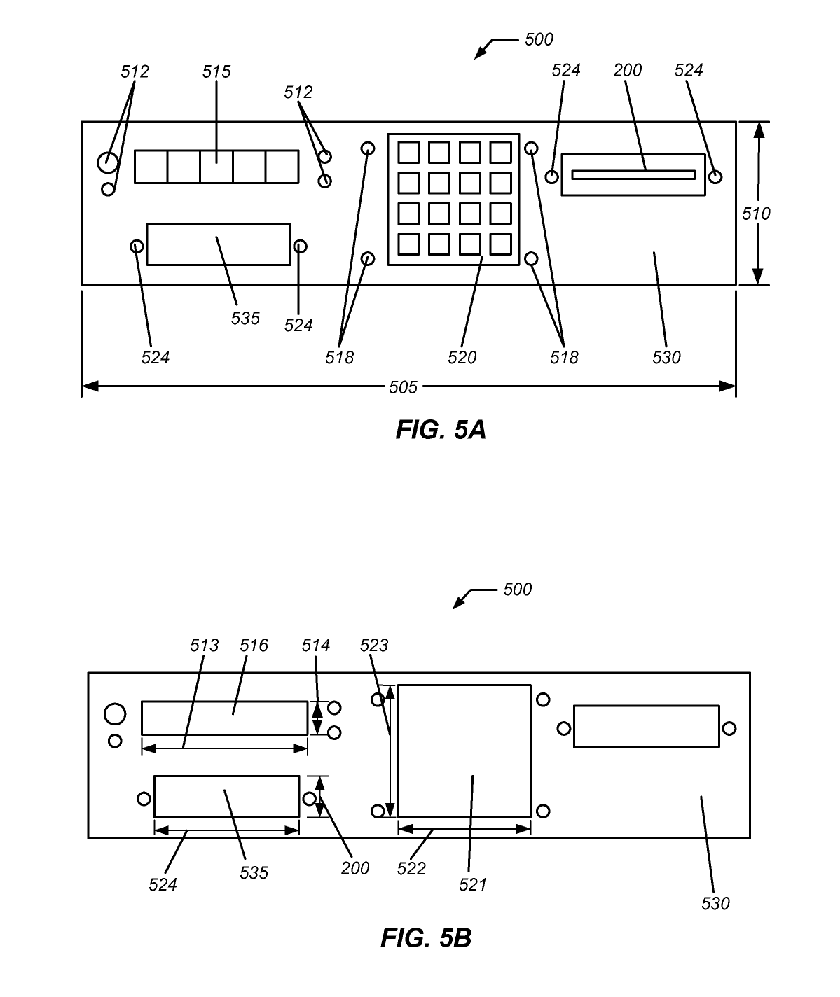

FIG. 4 depicts operations of method 400 according to some implementations described herein. Method 400 may be performed, at least in part, by a controller of a card reader and/or by a controller of an associated device, such as a player tracking unit, a gaming machine, a vending machine, a security system, etc. In block 400, a card is detected by the card reader. In this example, it is determined whether the card has been fully inserted into the card reader (block 405). Operations 400 and 405 may be performed, at least in part, by one or more detectors (such as switches, optical sensors, pressure sensors, etc.) of a card reader. The detector(s) may, for example, be located in or near a frame 205 of a card reader 200. (See FIGS. 2A and 2B.)

If a card is detected but is not fully inserted, in this example a prompt will be made. (Block 410.) For example, a controller associated with the card reader may control an audio device and/or a display to provide an indication that the card is not fully inserted into the card reader.

In alternative implementations, there may not be a separate device that determines whether the card has been fully inserted. For example, the card reader may be configured to periodically obtain images from the card and to look for a predetermined pattern that corresponds with a valid code. If the predetermined pattern is present, the bar code may be read. If the predetermined pattern is not present, the card reader may provide an error message and/or enter a “sleep mode.”

However, in this embodiment, if it is determined that the card is fully inserted, an image will be captured of a first side of the card. (Block 415.) In this example, a first side of the card is illuminated by a first light source and an image of the first side of the card is conveyed via a first optical path to a light detector. For example, referring to FIG. 2B, the first side 105a of the card 100 may be illuminated by the light source 240a and an image of the first side 105a may be conveyed via mirrors 215d and 215c to camera 210.

In block 425, the image is analyzed for the presence of a predetermined pattern. The predetermined pattern may be within the bar code itself (e.g., as depicted in FIG. 1A) or elsewhere on the card. If the predetermined pattern is detected, the presence of the bar code has been verified and the bar code's orientation may be determined, so the bar code may be read. (Block 435.)

If the predetermined pattern is not detected in process 425, it is determined whether images from all optical paths have been analyzed. (Block 430.) If not, an image is captured from another optical path. (Block 415.) For example, referring to FIG. 2A, the second side 105b of the card 100 may be illuminated and an image of the second side 105b may be conveyed via mirrors 215a and 215b to camera 210. If the predetermined pattern is detected, the bar code may be read. (Block 435.)

If the predetermined pattern is still not detected in process 425, it is determined whether images from all optical paths have been analyzed. (Block 430.) If not, an image is captured from another optical path. (Block 415.) However, if it is determined in process 430 that there are no additional optical paths, an error indication is provided in this example. (Block 455.) For example, a controller associated with the card reader may control an audio device and/or a display to provide an indication that the card cannot be read by the card reader.

If the card is read in process 435, it may be determined whether the bar code corresponds to that of a known type of player loyalty card. (Block 440.) This determination may be made by a local controller associated with the card reader, by a controller associated with another local device (such as a player tracking controller or a gaming machine controller), or by a remote device. For example, bar code data may be obtained by the bar code and transmitted to a remote device, such as a player loyalty server, via a network interface. The remote device may determine whether at least some of the bar code data correspond with a casino's player loyalty program and/or with a known player loyalty account.

If the bar code does not correspond to that of a known type of player loyalty card, an error indication may be provided. (Block 455.) For example, a player may have inserted a player loyalty card associated with another casino, or a card bearing a readable bar code that is not a bar code for a player loyalty card. A controller associated with the card reader may control an audio device and/or a display to provide a message, e.g., a prompt to insert another player loyalty card that associated with the casino.

However, if the bar code does correspond to a known type of player loyalty card, player loyalty information may be read from the card and provided to a player tracking unit to initiate player tracking functionality. (Block 440.) For example, player identity information, player preference information, point totals, etc., may be provided to the player tracking unit by a player tracking server if the bar code data correspond with player data in a player tracking database accessible by the player tracking server. Such player tracking functionality may continue until it is determined that the card has been removed (block 450) and/or until other predetermined indications have been observed (such as a zero credit balance for a predetermined period of time), at which time the process may end. (Block 460.)

FIGS. 5A through 5C are front and perspective diagrams of a player tracking unit that may include a card reader 200 as provided herein. FIG. 5A provides a frontal view of a housing or chassis 500 enclosing a player tracking unit. The device housing 500 may enclose a player tracking controller 310 configured to execute player tracking functions. Alternatively, the player tracking controller 310 may be enclosed in a controller housing separate from the device housing 500.

In this example, the device housing 500 encloses a display 515, a key pad 520 and a card reader 200. In other embodiments, the housing 500 may enclose many different combinations of player tracking devices. For instance, additional gaming devices, such as biometric devices and bonus buttons, may also be enclosed in the device housing. The display 515, key pad 520 and card reader 200 are mounted within a face plate 530. In this example, the face plate includes four mounting holes 512 for the display, four mounting holes for the key pad 518 and two mounting holes for the card reader 200. In addition, a card reader cut-out 535 and mounting holes 524 are included to allow an alternative placement of the card reader 200. Other configurations may be used, e.g., a vertical orientation of the card reader slot as shown in FIG. 2B.

The dimensions of the device housing 500 (e.g., 505, 508 and 510) are shown in FIGS. 5A and 5C. Dimensions of the display reader cut-out 516 (e.g. 513 and 514), the card reader cut-out (e.g. 524 and 525) and the key pad cut-out (e.g. 522 and 523) in the face plate 530 are shown in FIG. 5B. However, these figures are not necessarily drawn to scale and the relative element dimensions, orientations, are merely made by way of example. The device housing 500 is shown as a rectangular box for illustrative purposes only. Device housing 500 may have other shapes.

However, the dimensions and layout of the device housing may be designed to conform to one or more gaming machine industry standards. A few examples of these standards are described for illustrative purposes and are not meant to be limiting. For instance, to simplify the packaging of the gaming machine, the shape of the device housing may be constrained to fit within the rectangular dimensions 505, 508 and 510 specifying the rectangular device housing 500. As another example, the dimensions of the cut-outs for the various player tracking devices and a size, shape and number of the mounting holes for each device may be standardized. An advantage of this standard is that one particular type of particular player tracking device may be exchanged for another particular type of player tracking device such as exchanging one brand of card reader for another brand of card reader. As yet another example, the layout of the device housing may be standardized. For instance, all device housing that are mounted horizontally may use a face plate with cut-outs and mounting holes in a fixed relation to one another such as face plate 530. A standard face plate layout may simplify the design of decorative plates for each gaming machine. As yet another example, a standard connection scheme such as USB may be used for the device housing 500 for communicating with a master gaming controller on a gaming machine. The standards described above relating to dimensions and layout may also apply to the design of controller housings (not shown) to produce standard controller housings.

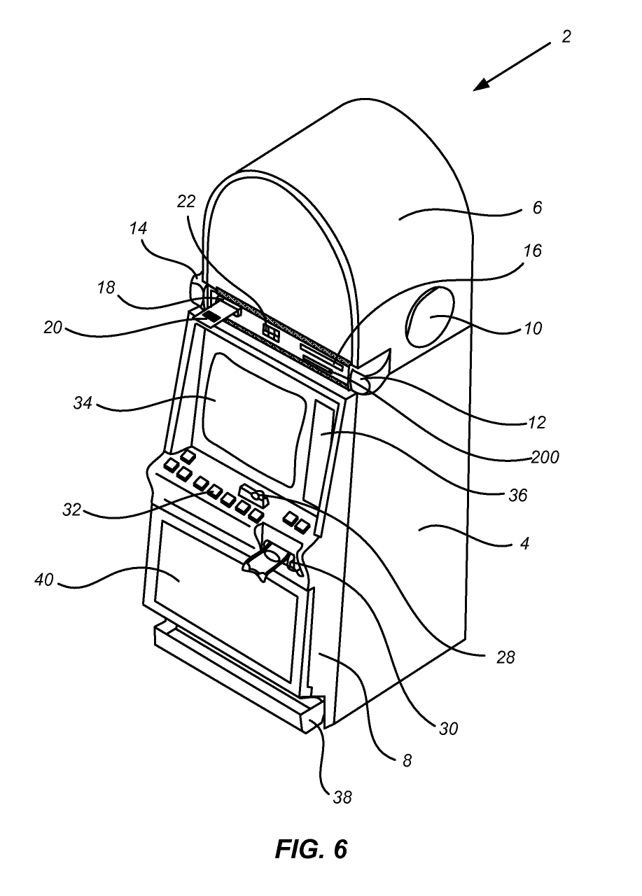

Turning to FIG. 6, a video gaming machine 2 is shown. Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a belly glass 40. Viewable through the main door is a video display monitor 34 and an information panel 36. The display monitor 34 may be a cathode ray tube, high resolution flat-panel LCD, or another type of electronically controlled video monitor. The information panel 36 may include lettering to indicate general game information including, for example, the number of coins played. The bill validator 30, player-input switches 32, video display monitor 34, and information panel are devices used to play a game on the game machine 2. The devices are controlled by circuitry housed inside the main cabinet 4 of the machine 2. Many types of games, including traditional slot games, video slot games, video poker, and keno, may be provided by such gaming machines.

In this example, the gaming machine 2 includes a top box 6, which is positioned on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a display 16 for displaying player tracking information and a card reader 200 for entering a magnetic striped card or smart card containing player tracking information. Further, the top box 6 may house different or additional devices than shown in the FIG. 6. For example, the top box may contain a bonus wheel or a back-lit silk screened panel which may be used to add bonus features to the game being played on the gaming machine. During a game, these devices are controlled and powered, in part, by circuitry (see FIG. 2) housed within the main cabinet 4 of the machine 2.

Gaming machine 2 is but one example from a wide range of gaming machine designs on which the present invention may be implemented. For example, not all suitable gaming machines have top boxes. Further, some gaming machines have two or more display devices, which may be mechanical and/or video displays. Moreover, some gaming machines are designed for bar tables and have displays that face upwards. Those of skill in the art will understand that the present invention, as described herein, can be deployed on various gaming machines now available or hereafter developed.

When a user wishes to play the gaming machine 2, he or she may insert cash through the coin acceptor 28 or bill validator 30. In this example, the bill validator is configured to accept a printed ticket voucher that may be accepted by the bill validator 30 as an indicium of credit. During the game, the player may view game information and game play using the video display 34.

Prior to initiating game play on the gaming machine, the player may enter playing tracking information using the card reader 200, the keypad 22, and/or the display 16, which may be contained in a player tracking unit as previously described. As another example, the player may enter playing tracking information using the card reader 200. In some embodiments, one or more video displays of the gaming machine 2 is configured to be used as a touch screen to enter information. Some such embodiments do not include the key pad 22.

During the course of a game, a player may be required to make a number of decisions that affect the outcome of the game. For example, a player may vary his or her wager on a particular game, select a prize for a particular game, or make game decisions which affect the outcome of a particular game. The player may make these choices using the player-input switches 32, the video display screen 34 or some other device that enables a player to input information into the gaming machine. Certain player choices may be captured by player tracking software loaded in a memory of the gaming machine and/or of a player tracking unit. For example, the rate at which a player plays a game, the type of game selected by the player and/or the amount a player bets on each game may be captured by the player tracking software.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects may include flashing lights, strobing lights or other patterns displayed from lights on the gaming machine 2 or from lights behind the belly glass 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18. The type of ticket 20 may be related to past game playing recorded by the player tracking software within the gaming machine 2. In some embodiments, these tickets may be used by a game player to obtain game services.

Gaming machine 2 may be configured for communication with other devices via a network interface, such as a network interface of a player tracking unit 300. Some such player tracking units 300 may be configured to request and/or to receive player tracking software from another device, such as a remote server. One advantage of downloading player tracking software from a remote server is that it may reduce memory requirements on the player tracking unit. For instance, a player tracking unit storing communication protocols and device drivers for a large number of devices may require more memory than a player tracking unit that downloads a specified player tracking software configuration from a remote server. In addition, the downloading of player tracking software from a remote server may simplify the process of upgrading player tracking software on a player tracking device in communication with the remote server.

The various illustrative logics, logical blocks, modules, circuits and algorithm steps described in connection with the embodiments disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), ASIC, a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some embodiments, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the embodiments described in this disclosure may be readily apparent to those skilled in the art, and the generic principles defined herein may be applied to other embodiments without departing from the spirit or scope of this disclosure. Thus, the disclosure is not intended to be limited to the embodiments shown herein, but is to be accorded the widest scope consistent with the claims, the principles and the novel features disclosed herein. The word “exemplary” is used exclusively herein to mean “serving as an example, instance, or illustration.” Any embodiment described herein as “exemplary” is not necessarily to be construed as preferred or advantageous over other embodiments. Additionally, a person having ordinary skill in the art will readily appreciate, relative terms such as “upper” and “lower” are sometimes used for ease of describing the figures, and indicate relative positions corresponding to the orientation of the figure on a properly oriented page. Such terms may not reflect the proper orientation (or the only orientation) of the device as implemented.

We claim:

1. A wager gaming machine, comprising:
apparatus for accepting indicia of credit;
apparatus for providing wagering games;
apparatus for accepting wagers relating to the wagering games;
a master gaming controller configured to control the apparatus for providing wagering games according to received wagers and indicia of credit; and
a card reader, comprising:
a frame configured for receiving a card;
a camera;
a first optical pathway configured for conveying an image of a first side of the card to the camera;
a second optical pathway configured for conveying an image of a second side of the card to the camera; and
a card reader controller configured for determining whether the first side of the card or the second side of the card includes a bar code, the card reader controller being configured for communication with the master gaming controller.

2. The wager gaming machine of claim 1, further comprising a player tracking unit that includes the card reader.

3. The wager gaming machine of claim 1, further comprising a network interface, wherein the card reader controller is further configured for:
reading bar code data from the bar code;
sending the bar code data to a remote device via the network interface; and
receiving an indication from the remote device regarding whether the bar code contains player tracking account information.

4. A card reader, comprising:
a frame configured for receiving a card;
a camera that is fixedly positioned relative to the frame;
a first optical pathway configured for conveying an image of a first side of the card to the camera;
a second optical pathway configured for conveying an image of a second side of the card to the camera; and
a controller configured for determining whether the first side of the card or the second side of the card includes a bar code.

5. The card reader of claim 4, wherein the controller is further configured for reading the bar code.

6. The card reader of claim 4, wherein the controller is further configured for determining whether the bar code contains player tracking account information.

7. The card reader of claim 4, wherein the bar code is a two-dimensional bar code.

8. The card reader of claim 4, further comprising an interface, wherein the controller is further configured for communication with a wager gaming machine via the interface.

9. The card reader of claim 4, wherein the first optical pathway comprises a first pair of mirrors and wherein the second optical pathway comprises a second pair of mirrors.

10. The card reader of claim 4, wherein the first optical pathway and the second optical pathway share at least one element.

11. The card reader of claim 4, wherein the frame includes at least one element of the first optical pathway or the second optical pathway.

12. The card reader of claim 4, wherein the frame comprises a detector configured to determine whether the card has been fully inserted into the frame.

13. The card reader of claim 5, wherein the controller is configured for reading the bar code regardless of whether the bar code is on the first side of the card or the second side of the card.

14. The card reader of claim 5, further comprising a network interface, wherein the controller is further configured for:
sending bar code data to a remote device via the network interface; and
receiving an indication from the remote device regarding whether the bar code contains player tracking account information.

15. A player tracking unit comprising the card reader of claim 6.

16. A wager gaming machine comprising the player tracking unit of claim 15.

17. A method, comprising:
receiving, at an image capturing device, a first image of a first side of a card from a first mirror;
receiving, at the image capturing device, a second image of a second side of the card from a second mirror;
determining, by a controller configured for communication with the image capturing device, whether the first image or the second image includes a bar code; and
reading the bar code if it is determined that the first image or the second image includes a bar code.

18. The method of claim 17, further comprising determining whether the card has been fully inserted into a card reader.

19. The method of claim 17, wherein the determining process involves determining whether a pattern is detected in the first image or the second image.

20. The method of claim 17, wherein the bar code is a two-dimensional bar code.

21. The method of claim 17, wherein the bar code includes player tracking information, further comprising sending the player tracking information to a player tracking server.

22. The method of claim 18, further comprising providing an audio or visual prompt if it is determined that the card has not been fully inserted into the card reader.

23. The method of claim 19, wherein the determining process involves determining whether the pattern is a position pattern or an alignment pattern.

24. An apparatus, comprising:
means for receiving a first image of a first side of a card and for receiving a second image of a second side of the card;
means for determining whether the first image or the second image includes a bar code; and
means for reading the bar code if the determining means determines that the first image or the second image includes a bar code.

25. The apparatus of claim 24, wherein the bar code is a two-dimensional bar code.

26. The apparatus of claim 24, wherein the bar code includes player tracking information, further comprising means for sending the player tracking information to a player tracking server.

27. A tangible medium having software stored thereon, the software including instructions for controlling at least one device to perform the following operations:
receive a first image of a first side of a card;
receive a second image of a second side of the card;
determine whether the first image or the second image includes a bar code; and
read the bar code if it is determined that the first image or the second image includes a bar code.
